(19) United States
(12) Patent Application Publication
(10) Pub. No.: US 2009/0311539 A1
(43) Pub. Date: Dec. 17, 2009

(54) WEAR-RESISTANT COATING FOR POLYMERIC TRANSPARENCIES

(75) Inventors: Kjersta L. LARSON-SMITH, Seattle, WA (US); Vasan S. SUNDARAM, Issaquah, WA (US); Michael Robert SIRKIS, Seattle, WA (US)

Correspondence Address: MCNEES WALLACE & NURICK LLC, 100 PINE STREET, P.O. BOX 1166, HARRISBURG, PA, 17108-1166, US

(73) Assignee: THE BOEING COMPANY, Chicago, IL (US)

(21) Appl. No.: 12/137,390

(22) Filed: Jun. 11, 2008

(51) Int. Cl. B32B 9/04; H05H 1/24

(52) U.S. Cl. 428/446; 427/579

(57) ABSTRACT

A coating and associated method for coating is disclosed. The coating provides a hard, transparent coating to a substrate. A soft coating is first deposited upon the substrate, and a hard coating is then deposited upon the soft coating layer. The soft and hard coating layers both have the general composition SiOₓC_{y}. Multiple alternating layers of a soft and hard coating may be deposited. The soft and hard coatings are deposited by a plasma vapor deposition process.

### FIELD OF THE INVENTION

This invention relates generally to a wear resistant coating, and more particularly, to a dual layer transparent plasma-based durable transparent coating for plastic substrates.

### BACKGROUND OF THE INVENTION

Plastics are finding increasing use in manufactured goods. For example, certain automobiles have plastic body panels, and aircraft have plastic interior paneling and exterior skin panels formed of plastics and plastic composites. While plastics offer several excellent properties including light weight, formability, and low cost, plastics also have significant disadvantages. In general, plastic surfaces are not as hard or abrasion resistant as metal surfaces. Furthermore, while some plastics may be transparent, glass, which is much heavier and more expensive, remains the material of choice in certain critical applications such as safety glass in automobiles and in passenger aircraft windshields. Substituting polymeric materials such as stretched acrylic or polycarbonate would lead to lighter transparencies, but would also pave the way for re-designing the overall shape of cockpits, for example. Currently, stretched acrylic materials are used to fabricate aircraft passenger windows. Acrylic is used because of its flexibility, light weight, and easy formability. However, acrylic is a soft material and hence can be easily scratched. Water absorption, chemical attack, and mechanically induced scratches can lead to crazing when stress is applied to acrylic materials, as in a passenger window application.

Industry wide, polymer based transparencies are protected against wear and other chemical/nature induced degradation through siloxane coatings. At the present time, polycarbonate and other types of polymeric windows are protected by sol-gel based polysiloxane coatings. The sol-gel coatings are homogeneous mixtures of a solvent, an organosilane, an alkoxide and a catalyst that are processed to form a suitable coating. The sol-gel coatings provide high transmittance and limited durability against wear and UV induced degradation. The term sol-gel or solution-gelation refers to materials undergoing a series of reactions like hydrolization and condensation. Typically, a metal alkoxide or metal salt is hydrolyzed to form a metal hydroxide. The metal hydroxide then condenses in solution to form a hybrid organic/inorganic polymer. The ratio of organic to inorganic components in the polymer matrix is controlled to maximize the performance for a given application. For example, increasing the organic groups would improve flexibility but may compromise wear and environmentally induced durability. The sol-gel coating may include materials such as cerium or titanium to improve abrasion resistance and ultraviolet induced degradation of the coatings. A typical application process would consist of component surface cleaning, followed by the application of the coating via a flow, spray or dip process. The surface cleaning may be achieved by solvent wiping with, for example, isopropyl alcohol or exposing the component to oxygen plasma. The sol-gel coatings can be cured at room temperature or elevated temperatures. For example, stretched acrylics must be cured at temperatures less than 180° F.

The coatings used at the present time exhibit only a moderate durability. There is a need for a transparent, hard coating with excellent durability that would improve component lifetime. The needed coating should provide improved resilience against chemicals commonly encountered in product maintenance and also excellent weatherability characteristics. The needed coating should be both hard and flexible, so that it tolerates the flexing of the polymeric material due to operation and thermal stresses. The needed coating should be provided by a simple process and at a low cost.

There is a need for an improved wear resistant coating for polymeric transparencies. The present invention fulfills this need, and further provides related advantages.

The foregoing examples and limitations associated therewith are intended to be illustrative and not exclusive. Other limitations of the related art will become apparent to those of skill in the art upon reading of the specifications and study of the drawings.

### SUMMARY OF THE INVENTION

The following embodiments and aspects thereof are described and illustrated in conjunction with systems and methods that are meant to be exemplary and illustrative, not limiting in scope. In various embodiments, one or more of the problems described above in the Background have been reduced or eliminated, while other embodiments are directed to other improvements.

A first embodiment of the invention includes a coating formed on a substrate. The coating includes a soft coating and a hard coating. The soft coating and the hard coating are formed upon the substrate by a plasma deposition process. The soft coating and the hard coating have the general formula SiOₓC_{y}.

A second embodiment of the invention includes a method of forming a coating on a substrate. The method includes providing a substrate, despositing a soft coating upon the substrate, and depositing a hard coating upon the soft coating. The soft coating and the hard coating are deposited by a plasma deposition process. The soft coating and the hard coating have the general formula SiOₓC_{y}.

A third embodiment of the invention includes a composite article including a substrate, a soft coating disposed upon the substrate, and a hard coating disposed upon the soft coating. The soft coating and the hard coating are formed upon the substrate by a plasma deposition process, the soft coating and the hard coating having the general formula SiOₓC_{y}.

One advantage of the present invention is to provide a transparent, hard coating with excellent durability that improves component lifetime.

Another advantage of the present invention is to provide a transparent, hard coating that is both hard and flexible

Another advantage of the present invention is to provide a transparent, hard coating that provides improved resistance against chemicals commonly encountered in product maintenance.

Yet another advantage is to provide a transparent, hard coating providing excellent weatherability characteristics.

Another advantage of the present invention is to provide a streamlined process for applying a transparent, hard coating.

Another advantage is providing a transparent hard coating at temperatures compatible with the substrates or without damaging the substrate or degrading its physical properties.

Another advantage is that the coating composition can be substantially seamlessly varied within the coating thickness.

Further aspects of the method and apparatus are disclosed herein. Other features and advantages of the present invention will be apparent from the following more detailed description of the preferred embodiment, taken in conjunction with the accompanying drawings that illustrate, by way of example, the principles of the invention.

### BRIEF DESCRIPTION OF THE DRAWINGS

FIG. 1 is an exemplary embodiment of an applied coating according to the invention.

FIG. 2 is a graph showing the results of a Tape Adhesion Test of an exemplary coating in accordance with an embodiment of the invention.

FIG. 3 is a graph showing the results of a Falling Sand Erosion Test of an exemplary coating in accordance with an embodiment of the invention.

FIG. 4 is a graph showing the results of a Taber Wear Test of an exemplary coating in accordance with an embodiment of the invention

### DETAILED DESCRIPTION OF THE INVENTION

The present invention now will be described more fully hereinafter with reference to the accompanying drawing, in which a preferred embodiment of the invention is shown. This invention may, however, be embodied in many different forms and should not be construed as limited to the embodiments set forth herein; rather, these embodiments are provided so that this disclosure will be thorough and complete and will fully convey the scope of the invention to those skilled in the art. All composition percents are given as weight percents, unless otherwise specified.

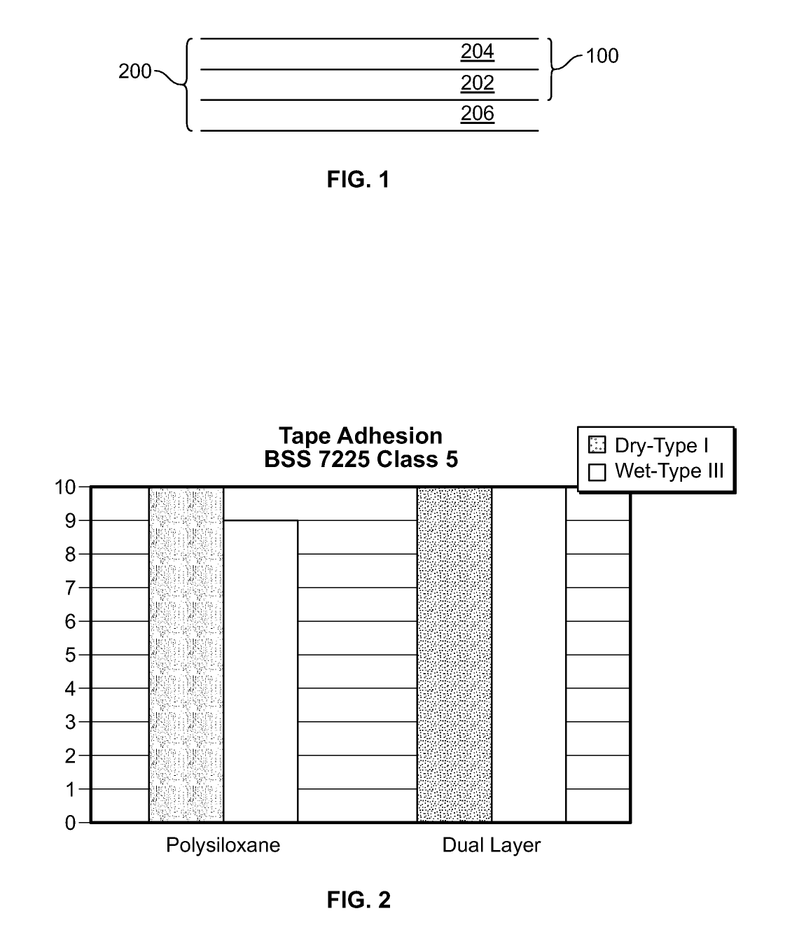

As illustrated in FIG. 1, an exemplary coated substrate 200 is disclosed. The coated substrate 200 includes a substrate 206 and an exemplary coating 100 disposed thereupon. The coating 100 includes alternating layers of a soft coating 202 and a hard coating 204. The substrate may be a metal, a rigid polymer material such as an acrylic, polycarbonate or plastic, a fiber reinforced polymer matrix, an amorphous material such as glass, or other similar material. The substrate may be a hard, soft, flexible or rigid material. The coating 100 benefits any substrate where the coating is harder than the substrate. In one embodiment, substrate 206 may be a common aircraft passenger window formed of acrylic or other similar polymeric material. In particular, the coating may be applied to stretched acrylic to improve crack growth resistance. In one embodiment, the coating may be applied to a stretched acrylic window.

The soft coating 202 has greater adhesion and flexibility characteristics relative to the hard coating 204. The greater adhesion and flexibility of the soft coating 202 improves the adhesion of the coating 100 to the substrate 206. The soft coating 202 provides a bonding layer and thus is deposited prior to depositing hard coating 204. Soft coating 202 need not be very thick to provide the adhesion benefit to the hard coating 204. The soft coating 202 may have a thickness of between about 3 μm and 7 μm. For example, the soft coating 202 may have a thickness of about 4 μm, 5 μm, or 6 μm The thickness of the soft coating 202 is sufficient to ensure the adhesion of hard coating 204 to substrate 206. The soft coating 202 has a general composition of SiOxCy having about 30% to about 35% Si, about 30% to about 35% C, and about 30% to about 35% O. The soft coating 202 has a hardness of about 0.5 GPa to about 1.5 GPa. Within this application, all composition percents are provided as weight percent.

The hard coating 204 has greater hardness, wear, and weatherability characteristics relative to the soft coating 202. The greater hardness, wear, and weatherability characteristics improve the resistance of the coating 100 against mechanical scratching, chemical attack, and environmental degradation. The hard coating 204 may have a thickness of between about 3 μm and 7 μm. For example, the hard coating 204 may have a thickness of about 4 μm, 5 μm, or 6 μm. The thickness of the hard coating 204 is sufficient to provide a desired durability to the coating 100. The hard coating 204 has a general composition of SiOₓC_{y} having about 30% to about 35% Si, about 25% to about 30% C, and about 40% to about 45% O. The hard coating 204 has a hardness of about 1.9 GPa to about 6.0 GPa.

The coating 100 improves resistance of the substrate 206 to surface effects. The abrasion resistance of the coating 100, as measured by the percent change in haze as measured in a Taber wear Test (ASTM D-1044-90), is more than two orders of magnitude better than that for a polysiloxane coated polycarbonate substrate. The erosion resistance of the coating 100, as measured by percent change in haze as measured in a Falling Sand Test (ASTM D 968-05), is more than a factor of three better than that for glass. In addition, the optical properties, including light transmittance in the visible region, clarity and haze, of a substrate 206 with a coating 100 disposed thereupon are approximately equal to the same properties of a substrate 206 with a single polysiloxane coating.

In the exemplary embodiment shown in FIG. 1, the coating 100 includes a single layer of a soft coating 202 and a single layer of a hard coating 204. However, in another embodiment, any number of layers of soft coating 202 and hard coating 204 layers may be provided in alternating layers, as long as the coating layer adjacent the substrate 206 is a soft coating 202 and the outermost layer is a hard coating 204. In another embodiment, the coating 100 may include two or more layers of each of the soft and hard coatings 202, 204. In yet another embodiment, layers of the soft coating 202 and/or the hard coating may vary in thickness. In still another embodiment, the coating 100 may include more than one soft coating 202 and more than one hard coating 202. For example, different soft coatings 202 and/or different hard coatings 204 may vary in composition and/or hardness.

As further shown in FIG. 1, the coating 100 is formed upon a substrate 206 to form a coated article 200. For example, in the aircraft industry, the substrate 206 may be an acrylic aircraft window, an airplane cockpit, an airplane navigation light lens, and fiberglass-epoxy radomes. Additionally, the substrate need not be limited to the aircraft industry. Additional substrates include polycarbonate cases for consumer electronics, cell phone touch screens, automobile parts and panels including, but not limited to, polymeric automobile body panels and windows and other industry applications exposed to wear and damage.

The coating 100 is formed by depositing alternating layers of soft coating 202 and hard coating 204 having differing SiOₓC_{y} compositions as discussed above. The alternating layers are formed by using a plasma based deposition process. The alternating layers may be formed in a single step continuous process or may be formed by a multiple step discontinuous process. A substantially seamless material transition exits between the alternating layers of the soft coating 202 and the hard coating 204, which results from the use of the plasma deposition process to deposit both layers. In one embodiment, the alternating layers are formed in a single coating process without removing the substrate from the process chamber. In yet another embodiment, the substrate is not removed from the process chamber and input parameters such as chemical gas flow rates, are varied during the coating process. By controlling and adjusting the deposition process parameters, individual layer characteristics including layer thickness, hardness and modulus may be controlled and individually selected for each deposited layer. Furthermore, deposition parameters such as bias voltage, pressure, temperature and flow rate can be controlled and adjusted to influence the microstructure of the coating and its relative hardness or softness. Thus, two coatings with the same chemical composition may have different coating densities having different hardness and modulus characteristics.

The plasma based deposition process of the current invention uses a plasma-enhanced chemical vapor deposition (PECVD) that uses the energy of plasma electrons to disassociate process gases. The plasma source includes a radio frequency or microwave power source and an appropriate applicator. For example, a plasma reactor using microwave power at 2.45 GHz may be used to dissociate and ionize the process gasses. The layers can be deposited at low substrate temperatures of between about 20° C. to about 30° C. The PECVC conditions, such as gas flow, deposition pressure, and plasma power may be adjusted to produce a hard, transparent coating in accordance with known plasma deposition principles.

The process further employs the principal of Electron Cyclotron Resonance (ECR), in which a static magnetic field is applied along the direction of microwave propagation. Resonance occurs when the microwave radian frequency ω is equal to the cyclotron frequency ω_{c}=qB/mₑ, where q is the electronic charge, B is the magnetic field strength, and mₑ is the electron mass. If f=2.45 GHz, the resonance field value is 875 Gauss. At resonance, the electrons gyrate in synchronism with the oscillating microwave field. The plasma electrons are thus accelerated by the microwave field.

The process gas used in this deposition process is oxygen used in combination with an organosilicon precursor. For example, the precursor gas may be any one of octamethycyclotetrasiloxane (C₈H₂₄O₄Si₄)), also know as OMCTS, hexamethyldisiloxane (Si₂C₆H₁₈O), tetramethylcyclotetrasiloxane (Si4C4H16O4), and octamethylcyclotetrasiloxane ((SiO)₄(CH₃)₈). In one embodiment, OMCTS is used as the precursor gas. The OMCTS vapor pressure at room temperature is approximately one Torr, which greatly facilitates vapor introduction into the process chamber. Addtionally, the Hazardous Materials Identification System (HMIS®) hazard rating for OMCTS is 1-2-0, which means that OMCTS is about as safe as a typical house paint. In another embodiment, combinations of different precursor gases may be used.

To deposit the alternating layers of SiOₓC_{y}, the OMCTS is heated to about 70° C. to increase vapor pressure of the OMCTS. The vapor is then metered into the process chamber by a heated mass flow controller. The vapor is introduced just above the substrate through four ports equally spaced around the chamber, while oxygen O₂ is injected through four ports located under the input microwave window. The ratio of OMCTS to O₂ (OMCTS/O₂) is between about 40-60 to form a soft layer and is between about 15-35 to form a hard layer. In one embodiment, the substrate is neither heated or cooled by external systems and/or methods, and is at ambient temperature at the start of the deposition process. The substrate temperature may increase as a result of the coating deposition. In another embodiment, the substrate temperature is less than about 100° C. during the deposition.

In one embodiment, referred to as Example 1, a coating 100 was formed by using an OMCTS/O₂ of between about 45% to about 55% to form a soft coating 202 having a composition of about 31% to about 33% Si, about 33% to about 35% C, and about 31% to about 33% O, and having a hardness of about 1.5 Gpa to about 1.65 Gpa. A hard coating 204 was then formed upon the soft coating 202 by using a OMCTS/O₂ of between about 20% to about 30% having a composition of about 31% to about 33% Si, about 25% to about 27% C, and about 40% to about 42% O, and having a hardness of about 1.9 GPa to about 2.0 GPa.

In one embodiment, substrate 206, prior to being loaded into a plasma deposition chamber for the application of the coating 100, may be first chemically cleaned to remove contaminants such as hydrocarbons and other undesirable materials. The cleaning process may be accomplished using, for example, ultrasonic cleaning in solvents or aqueous detergents. Once the desired vacuum conditions are obtained, substrate 206 may be sputter cleaned using inert ions and/or oxygen ions. Once the cleaning step is complete, the hard coating application can commence.

With no intent to limit the present invention, to validate the improved performance of coating 100 versus the currently used polysiloxane coating in applications using acrylic substrates, the following comparisons are made. In all comparisons, polysiloxane samples were formed by coating a polycarbonate substrate with a 4 μm polysiloxane coating by dip coating, and samples were formed by coating a polycarbonate substrate with a coating including approximately a 4 μm soft coating and a 4 μm hard coating having the chemical and physical characteristics as found in Example 1 above.

Adhesion to Substrate Test. Coating adhesion to the substrates were tested. The tests were performed according to BSS 7225 Class 5, “Adhesion, Tape Test”. Adhesion was analyzed for dry samples and after a 24 hour water soak (Type 1 and III). Results are shown in FIG. 2. The coating had excellent adhesion for both wet and dry tests with score of 10. The polysiloxane coating degraded slightly after the 24 hour water soak, but still passed with a score of 9. All coatings with an adhesion of 8 or higher are passing according to the criteria of this exemplary test.

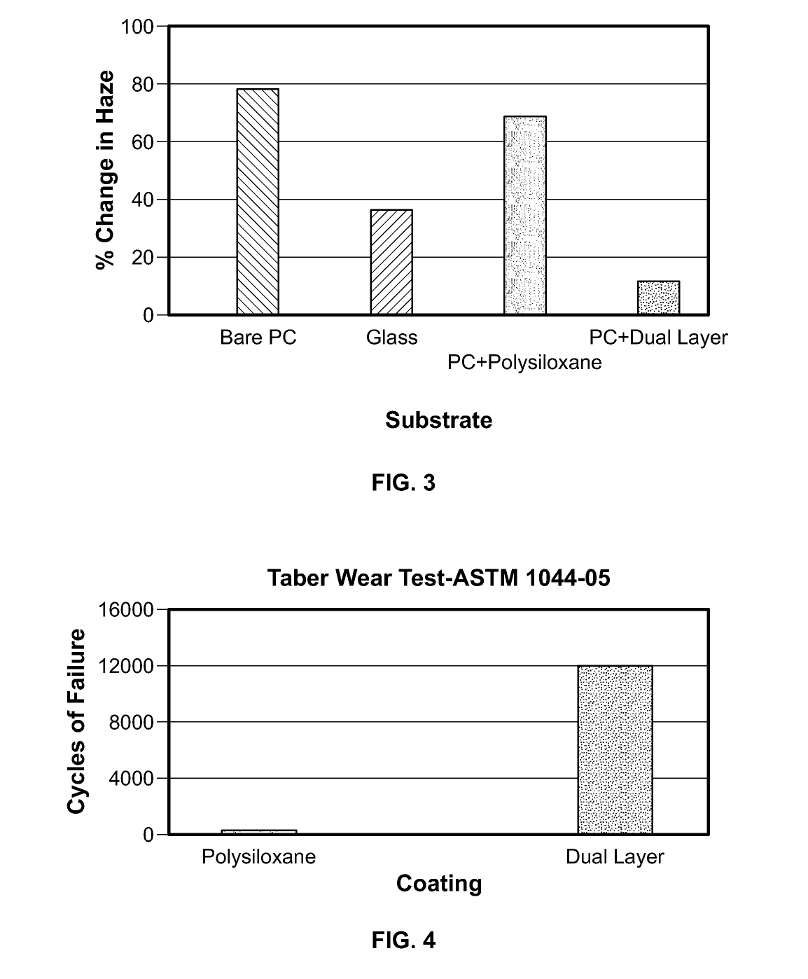

Erosion Test. Coated substrates were tested for the effect of sand erosion on optical haze. The tests were done in accordance with the procedure described in ASTM D968-93, “Standard Test methods for Abrasion Resistance of Organic Coatings by Falling Abrasive”. The sand used in these tests had a mean diameter of 800 μm. In these erosion tests, the increase in haze was used as the criteria for measuring the severity of erosion. The results are summarized in FIG. 3. The coating on polycarbonate exhibits a haze of 16% after sand impingement, while the polysiloxane coating has a haze of 69% which is four times greater. Bare glass has a change in haze of 37%. The coating has a resultant haze less than half of glass, which shows it is a possible replacement.

Wear Test. Coated substrates were tested for wear in accordance with the procedure described in ASTM D-1044-90, “Standard Test Method for Resistance of Transparent Plastics to Surface Abrasion”. This test consists of two CS-10F wheels to which a predetermined weight of 500 gm load is applied. The wheels abrade the coated substrate surface as it rotates on a table. The increase in haze is used as the criteria for measuring the severity of abrasion. The tests were run until the haze increased by 5% as a result of abrasion. The results are shown in FIG. 4. The coating survived 12,000 cycles before reaching 5% haze. This is over two orders of magnitude greater than the polysiloxane coating that survived 100 cycles. Therefore the coating has far superior durability when compared to the current standard coating.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. It is therefore intended that the following appended claims and claims hereafter introduced are interpreted to include all such modifications, permutations, additions, and sub-combinations as are within their true spirit and scope.

1. A coating formed on a substrate, comprising:
a soft coating; and
a hard coating;
wherein the soft coating and the hard coating have the general formula SiOₓC_{y}.

2. The coating of claim 1, wherein the soft coating comprises about 30% to about 35% Si, about 30% to about 35% C, and about 30% to about 35% O.

3. The coating of claim 1, wherein the soft coating has a hardness of about 0.5 GPa to about 1.5 GPa.

4. The coating of claim 1, wherein the hard coating comprises about 30% to about 35% Si, about 25% to about 30% C, and about 40% to about 45% O.

5. The coating of claim 1, wherein the hard coating has a hardness of about 1.9 GPa to about 6.0 GPa.

6. The coating of claim 1, wherein the soft coating has a thickness of between about 3 μm and 7 μm.

7. The coating of claim 1, wherein the hard coating has a thickness of between about 3 μm and 7 μm.

8. The coating of claim 1, further comprising multiple alternating layers of the soft coating and the hard coating.

9. The coating of claim 1, further comprising a substantially seamless transition between the soft coating and the hard coating.

10. A method of forming a coating on a substrate, the method comprising:
providing a substrate;
depositing a soft coating upon the substrate; and
depositing a hard coating upon the soft coating;
wherein the soft coating and the hard coating are deposited by a plasma deposition process, the soft coating and the hard coating having the general formula SiOₓC_{y}.

11. The method of claim 10, wherein plasma deposition process is continuous.

12. The method of claim 10, wherein the plasma deposition process is discontinuous.

13. The method of claim 10, wherein the substrate is at a temperature of less than about 100° C. during the forming of the coating.

14. The method of claim 10, further comprising depositing another soft coating upon the hard coating, and depositing another hard coating upon the another soft coating.

15. The method of claim 14, wherein more than one alternating layers of another soft coating and another hard coating are deposited.

16. The method of claim 10, wherein the soft coating comprises about 30% to about 35% Si, about 30% to about 35% C, and about 30% to about 35% O.

17. The method of claim 10, wherein the soft coating has a hardness of about 0.5 GPa to about 1.5 GPa.

18. The method of claim 10, wherein the hard coating comprises about 30% to about 35% Si, about 25% to about 30% C, and about 40% to about 45% O.

19. The method of claim 10, wherein the hard coating has a hardness of about 1.9 GPa to about 6.0 GPa.

20. The method of claim 10, wherein the soft coating has a thickness of between about 3 μm and 7 μm.

21. The method of claim 10, wherein the hard coating has a thickness of between about 3 μm and 7 μm.

22. The method of claim 10, wherein the substrate is a polymeric substrate.

23. A composite article comprising:
a substrate; and
a coating deposited upon the substrate,
wherein the coating comprises:
a soft coating disposed upon the substrate; and
a hard coating disposed upon the soft coating;
wherein the soft coating and the hard coating are formed upon the substrate by a plasma deposition process, the soft coating and the hard coating having the general formula SiOₓC_{y}.

24. The article of claim 23, wherein the soft coating comprises about 30% to about 35% Si, about 30% to about 35% C, and about 30% to about 35% O and has a hardness of about 0.5 GPa to about 1.5 Gpa.

25. The article of claim 23, wherein the hard coating comprises about 30% to about 35% Si, about 25% to about 30% C, and about 40% to about 45% O and has a hardness of about 1.9 GPa to about 6.0 GPa.

26. The article of claim 23, wherein the soft coating and the hard coating have a thickness of between about 3 μm and 7 μm.

27. The article of claim 23, wherein there is a substantially seamless transition between the soft coating and the hard coating.

28. The article of claim 23, wherein the coating comprises multiple alternating layers of the soft coating and the hard coating.

29. The article of claim 23, wherein the substrate is an acrylic aircraft window.

30. The article of claim 23, wherein the article is transparent.

31. The article of claim 23,wherein the coating is transparent.
